(19) United States
(12) Patent Application Publication
(10) Pub. No.: US 2016/0185280 A1
(43) Pub. Date: Jun. 30, 2016

(54) HANDS FREE BICYCLE SIGNALING SYSTEM

(71) Applicants: David J. Coles, Pittsburgh, PA (US); Michael R. Vindler, Pittsburgh, PA (US)

(72) Inventors: David J. Coles, Pittsburgh, PA (US); Michael R. Vindler, Pittsburgh, PA (US)

(21) Appl. No.: 14/966,895

(22) Filed: Dec. 11, 2015

Related U.S. Application Data
(60) Provisional application No. 62/124,192, filed on Dec. 11, 2014.

(51) Int. Cl. B60Q 1/26; B62J 6/00; A42B 3/04

(52) U.S. Cl. CPC B60Q 1/2676; A42B 3/0453; B62J 6/005

(57) ABSTRACT

A hands free bicycle signaling system is provided which allows a cyclist to communicate with drivers and others around him/her to increase the cyclist's and the others' safety. It includes helmet mountable safety related outputs, a power source, and a control unit. A safety related output can be voice activated.

### CROSS-REFERENCE TO RELATED APPLICATIONS

This is a perfection of Provisional Application Ser. No. 62/124,192, filed on Dec. 11, 2014, the disclosure of which is fully incorporated by reference herein.

### BACKGROUND OF THE INVENTION

As a long time urban commuter cyclist both on bicycles and motorcycles, I've become keenly aware of 2 very important safety facts: First the cyclist must keep communications open and acute with all traffic in their environment, both motor vehicles and pedestrians. Second, proper lighting communicates the fact that you are present.

Through the years, I have communicated with my environment while cycling with body language, eye contact, and arm gestures. I have found that speed, either too fast or too slow, road conditions and traffic are reasons to keep both hands on the handlebar to control a two-wheeled vehicle.

My experience has also taught me that I need to wear a helmet. So I went in search of a really cool helmet and to me cool meant protecting as much of my brain as I could. Soon I was on my way home with my “Nutcase” “Captain America” helmet. Almost immediately I wanted my cool helmet to have cool turning indicator lights. And those lights needed to communicate my thoughts to the environment without any physical action on my part. Because of my experience, I also wanted to encourage everyone who rides a two-wheeled vehicle to wear a helmet.

US 2011/0304478 A1 discusses a similar problem of visibility of cyclists. However the controls for the proposed system are on the handlebars, which may be a significant distraction to the cyclist and may pose a safety problem in and of itself. Also, any voice activation system on the handlebars will have significant problems due to wind noise, distance from the cyclist, and lack of control of the way the cyclist is facing compared to the microphone.

### BRIEF SUMMARY OF THE INVENTION

The hands free cycle signaling system is a light weight, compact control unit with iconic day bright turn indicators actuated by sound or voice, an accelerometer sensing motion or shaking of the head or general forward or lateral motion of the rider on the bike, or EEG. Indicators may be mounted to the helmet or many other surfaces. Indicators may be hardwired to the control unit or communicate with a control unit via Bluetooth. The unit optionally has an auditory and/or visual indicator letting the operator know what function is engaged.

A user activated signaling system mountable onto a helmet comprising at least one control unit that receives safety commands from the operator via one or more input devices. Said control unit processes said safety commands, and controllably activating one or more safety outputs based upon said commands. The system further comprises at least one power source to power at the at least one control unit and the one or more outputs.

The system may be helmet mountable assembly, for example a belt, a net, shell, or similarly stably helmet mountable assembly.

The user activated signaling system may use as at least one of the command input at least one microphone. The user activated signaling system may have at least one of the control unit, power source, inputs, and outputs are physically associable activated signaling system may have at least one, more than one, or all of the control unit, power source and dis-associable with a helmet. The user, inputs, and outputs are physically associable and dis-associable with a helmet in a non-permanent manner.

### BRIEF SUMMARY OF THE DRAWINGS

The accompanying figures, where like reference numerals refer to identical or functionally similar elements throughout the separate views, together with the detailed description below, are incorporated in and form part of the specification, and serve to further illustrate aspects of concepts that include the claimed invention, and explain various principles and advantages of those aspects.

FIG. 1. A system diagram of an aspect of this invention.

FIG. 2. A helmet with an aspect of this invention permanently or semipermantely added to it.

FIGS. 3A & 3B An rear turn signal display is comprised of a 2 dimensional array of light sources

FIGS. 4A & 4B A helmet mountable, self-contained hands free cycle signaling system

FIG. 5 Another helmet mountable, self-contained hands free cycle signaling system

FIGS. 6A, 6B, & 6C A chart of alternative aspects for the system

Skilled artisans will appreciate that elements in the figures are illustrated for simplicity and clarity and have not necessarily been drawn to scale. For example, the dimensions of some of the elements in the figures may be exaggerated relative to other elements to help to improve understanding of aspects of the present invention.

The apparatus and method components have been represented where appropriate by conventional symbols in the drawings, showing only those specific details that are pertinent to understanding the aspects of the present invention so as not to obscure the disclosure with details that will be readily apparent to those of ordinary skill in the art having the benefit of the description herein.

### DETAILED DESCRIPTION OF PREFERRED EMBODIMENTS

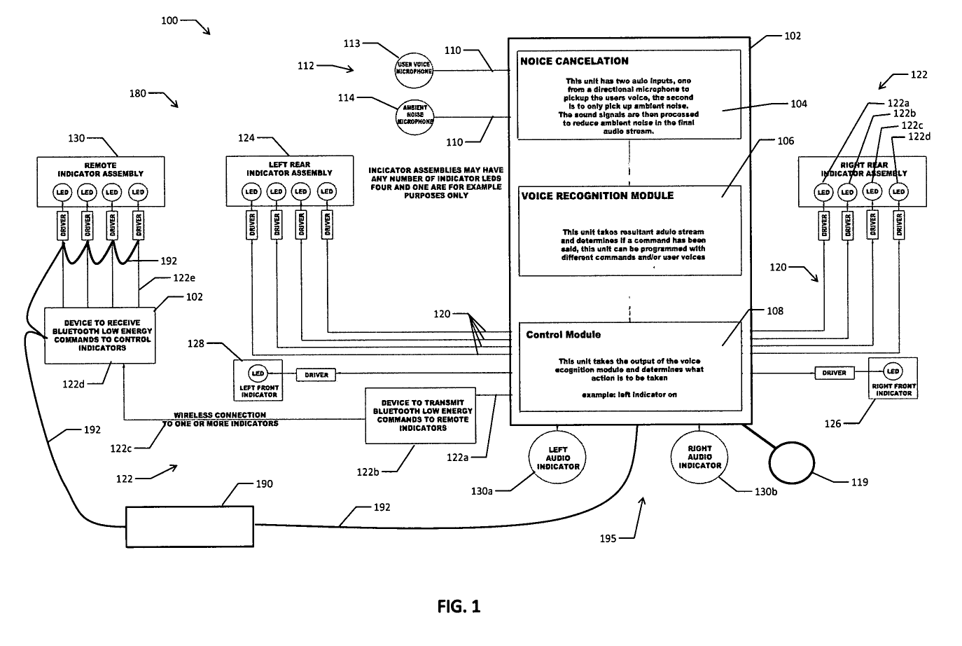

With reference to FIG. 1, the hands free cycle signaling system 100 comprises a control unit 102 consisting of a computer 108, preferably with internal memory and operating software, for example a Arduino or Raspberry Pi computer having one or more input ports 110 and one or more output ports 120. The system 100 further comprises a power source 190, for example light weight batteries, preferably rechargeable, with connections 192 to power the control unit 102 and optionally one or more input or output devices. The power source 190 may be housed in a polymer formed case. This unit is associable with, and preferably attachable permanently or temporarily to the helmet or embedded in and essentially a part of the helmet. Alternatively one or more aspects of the system may be attached to, mounted on, or stored in, a piece of clothing or otherwise associated with the rider or the bicycle. In an alternative aspect, more than one power sources may be used to reduce the amount of wiring needed, for example is an input or output device communicates wireless with the control unit 102, then it is likely that that input or output device will have a separate power source.

An additional aspect of the system 100 is the user safety related command input device 112. An example command input device 112 is a microphone 113 to capture voice commands. Optionally, one or more additional command input device 112, for example microphone 114 may be used as inputs to capture ambient sounds and be used by an optional noise cancellation algorithm and/or circuit 104 to clarify the voice command or help to differentiate it from background noise. The noise reduced command sound is analyzed by the voice recognition module 106 and a command, if present, is recognized by the control unit 108 and the appropriate action is taken.

Additional command input device 112 may include but are not limited to switches, buttons, light sensors, accelerometer or tilt sensors, cameras, and EMG or EEG input. Any of these inputs may be used alone or in conjunction with another input to provide commands or control signals or inputs to the control unit 102 which may affect the safety indicator outputs, settings, state, or mode of the overall system 100. These inputs may be embedded in the primary control system, wired to the system or use a wireless connection. The sensors may be located on the helmet, bicycle, or on the users body or clothing. The system may be turned on and off simply by disconnecting the system from the power. Alternatively, the system may remain powered but be in a low power or sleep state until one or more input is activated to indicate that it should begin operations. In addition, there may be one or more user system control input devices 119 which may provide commands to the system other than the safety related commands. For example control input devices 119 may turn the system on or off to save battery life or may switch through different modes, for example off, on, program safety command association.

The primary output of the system is the control of one or more safety related outputs 180, for example lighted or audible indicators, for example indicators 122, 124, 126, 128, and 130. The indicators consist of one or more groups of individual lighted emitters, panels, or areas. For example in one aspect, the right rear helmet turn signal indicator consists of 4 individually controllable segments, 122a, 122b, 122c, and 122d. These areas may be lighted in unison or individually in a pattern or sequence. Each panel or area may be comprised of one or more light emitting devices. The indicators may be located on, embedded into, hung from, or adhesively attached to the helmet, the bicycle, on the user's body or clothing, or any combination thereof. The indicators may be controlled by the control unit either through a direct wired connection 120, a wired connection to a remote location or through a wireless signal. An example setup to transmit a control signal wirelessly consists of wired output 122a, a blue tooth transmitter 122b, a radio signal 122c, a blue tooth receiver 122d, and wired outputs 122e to indicators 130. Multiple indicators may be used with a combination of multiple communication methods. Alternative user feedback outputs 195 may include sound for feedback to user, for example audio outputs 130a and 130b, sound outputs for signaling to others audibly for example by a horn, click or other sound, mechanical indication such as moving a flag up or down, vibration for feedback to user, or other physical means of feedback.

Example safety related conditions which may be commanded by the operator or user and indicated by the system include but are not limited to turning left, turning right, slowing, slow, stopped, hazard or emergency condition, increased visibility such as running lights, blinking lights, and indication of speed, for example rate of blinking proportional to speed, or front and back of bicycle with different colors, as is done with the parking and tail lights of automobiles.

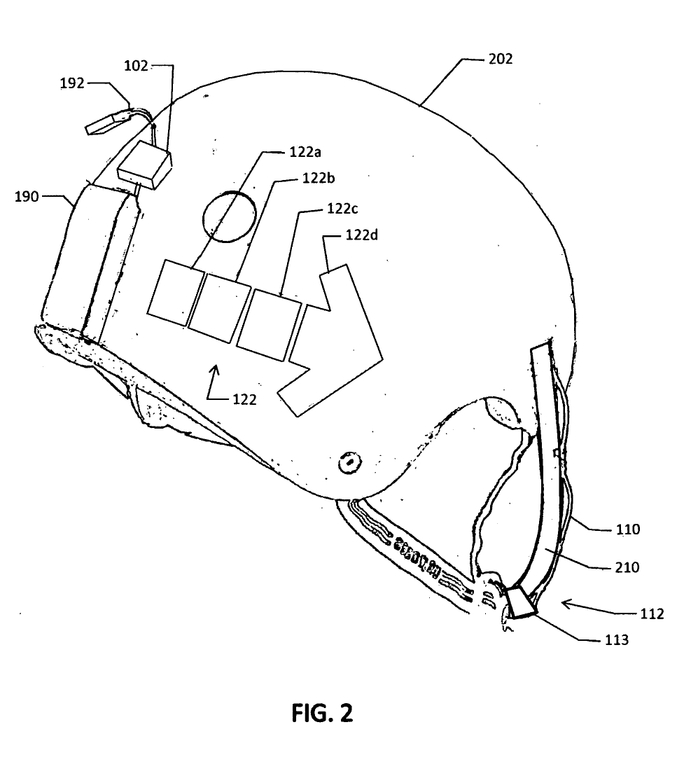

With reference to FIG. 2, an example aspect comprises two lighted, segmented arrow turn signals attached to a helmet 202. In the perspective of FIG. 2, the right rear turn signal 122 is visible. The right turn signal 122 is comprised of 4 segments, 122a, 122b, 122c, and 122d. When the right turn signal is activated, the segments may be illuminated in sequence from the center to the edge, or alternatively, they may come on and stay on, again moving from the center to the edge. A similar but leftward facing set of segments may comprise the left rear indicator assembly which is out of view on this perspective. In an alternative aspect, two similar arrays of segments may be placed on the front of the helmet so that traffic in the front of the rider may be informed of the rider's intentions.

Alternatively, the segmented arrows could be chevrons in the appropriate direction, mounted on both the front and rear parts of a helmet with double sided tape. Each chevron could have several LED's and be made of a translucent plastic with a scattering reflective backing so that the light is distributed and emitted over the chevron surface. The signal to turn right would be see clearly seen by another driver in front of, behind, or to the right of the cyclist. Similarly, the signal to turn left could be seen from another driver who is in front, behind, or to the left of the cyclist.

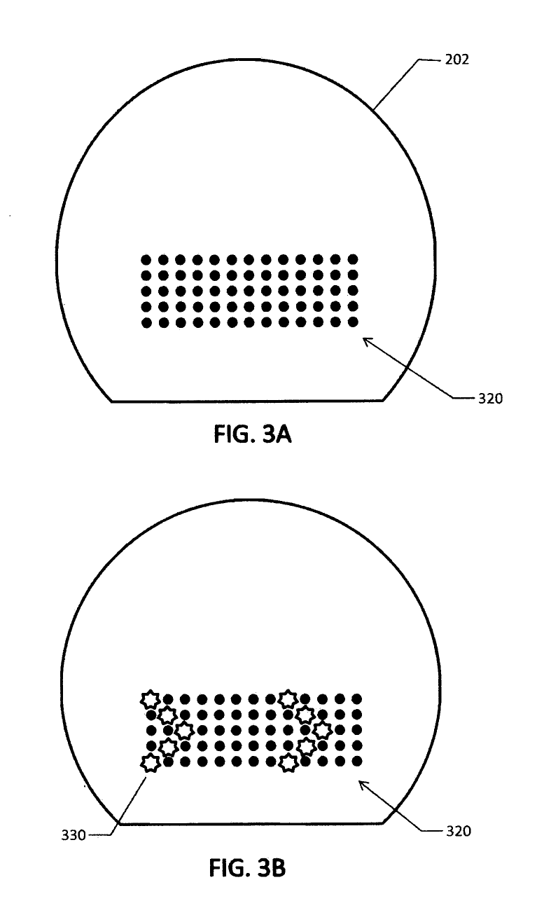

With reference to FIG. 3, the rear turn signal display is comprised of a 2 dimensional array of light sources which preferably wraps from the left side to the right side of the rear of the helmet. In this alternative aspect, overlapping arrow or chevron patterns may be created with this geometric array of discrete LED's so that the turn indication wraps all the way around the helmet from left to right and vice versa. In a further aspect, the front turn signal may be similarly constructed. In this aspect a motorist may be made aware of the cyclist's intentions on the matter wherever they are with respect to the cyclist operating the system.

In a further aspect, with the incorporation of an accelerometer into the helmet, the chevron turn signal pattern may automatically adjust it's starting and stopping point on the helmet, to indicate the proper direction of the turn even if the cyclist turns his head with respect to the forward motion or direction of the bicycle to look around him. Thus, for example, if the cyclist is indicating a right turn, and he turns his head 90° to the right, the chevrons would proceed from the front to the back of the helmet, which to a driver some distance would be seen as a chevron pattern indicating a turn to the right of the direction of the bicycle travel. Once the driver has made the turn and resumes facing forward, the movement of the chevron pattern would return to normal, or turn off as the turning action has been completed.

In a further aspect, the chevron pattern may be operating continuously at a middle or low light level optionally indicating the direction and/or speed of motion of the cyclist. For example the chevron pattern could be proceeding from the back to the front when the cyclist is moving forwards, and more quickly from back to front the faster the cyclist is moving. This would be an added safety indication to nearby motorists that the cyclist is there and moving.

In a system using audio input, when the cyclist or operator wished to activate a right turn signal, they speak the word “right turn” or some other operator selected phrase or phrases. The number of phrases is limited only by computer memory and command programming time. The system 102 recognizes the command and for example changes the chevron patter to a higher brightness and shifts the direction to be from the left to the right over both the back and the front of the helmet.

Alternatively, in a system equipped with an accelerometer, commands may be input by nodding the head to the right or the left.

Another aspect would use EEG (electroencephalograph) or EMG (electromyography) pickups, for example mounted inside the helmet and contact the skull to control the lighting with one's mind. The systems of Emotive of San Francisco, CA provide EEG input to compute systems. https.//emotiv.com/

As is recognized by one skilled in the art, the way that command inputs 112 are selected, programmed, or entered into the system is dependent upon command input types accepted and the command input devices used. For example EEG involves training the system and optionally uses and external computer and software. Voice command inputs 112 may involve recording one or more series of speech for each safety related output 180 recorded directly into the system. Accelerometer inputs levels may be preset in the construction of the system and not changeable by the user. Alternatively, accelerometer inputs (one or more of jerk, acceleration, velocity, or distance moved and spatial direction of motion) can be user selectable.

Another aspect has at least one of the outputs located off the helmet, with Bluetooth to control any number of systems in close proximity.

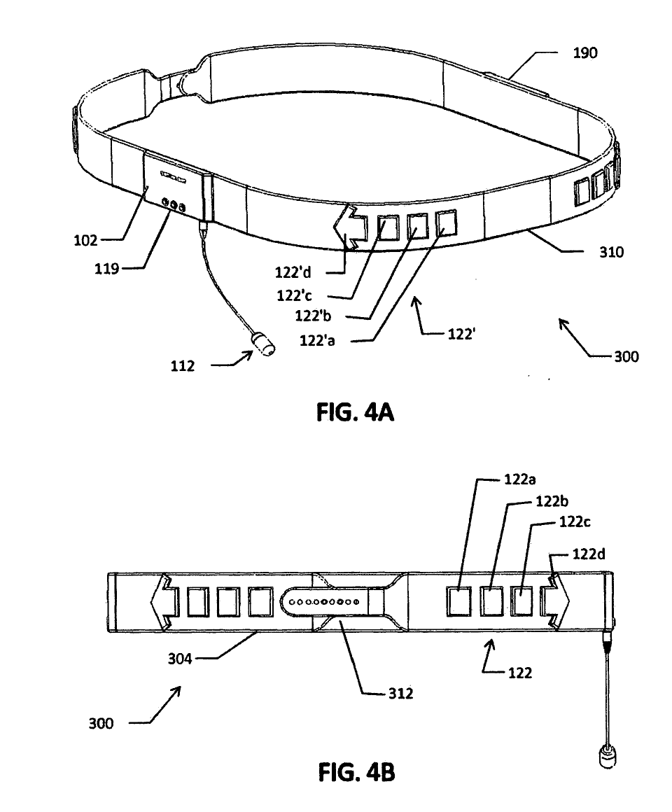

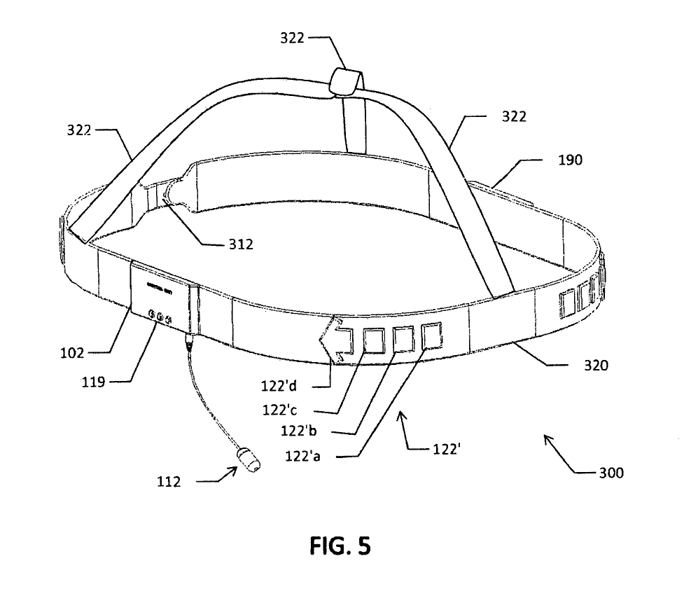

FIGS. 4A and 4B illustrate an aspect of this invention in which all or a significant portion of the system 100 is on an overpiece 300 designed to fit and stay onto a helmet (not shown). In this example, the overpiece 300 is a belt or band 310. The band 310 may be elastic to accommodate various size and designs of helmets. The inner side of the belt which contacts the helmet may have a rubbery, tacky, or permanently adhering adhesive to provide the desired strength and permanency of attach to the helmet. The band 310 may have a tightenable and or latchable mechanism 312, for example similar to those used on baseball caps or belts. The operator can adjust and place the system 100 on their helmet as they desire, and optionally move it to improve performance, appearance, or comfort as need be. The operator may also move the system 100 to a different helmet if desired. As an option, the user may wear just the overpiece 300 on their head, around their neck, or otherwise associated with their body, although it is desirable to encourage cyclists to wear helmets for their safety.

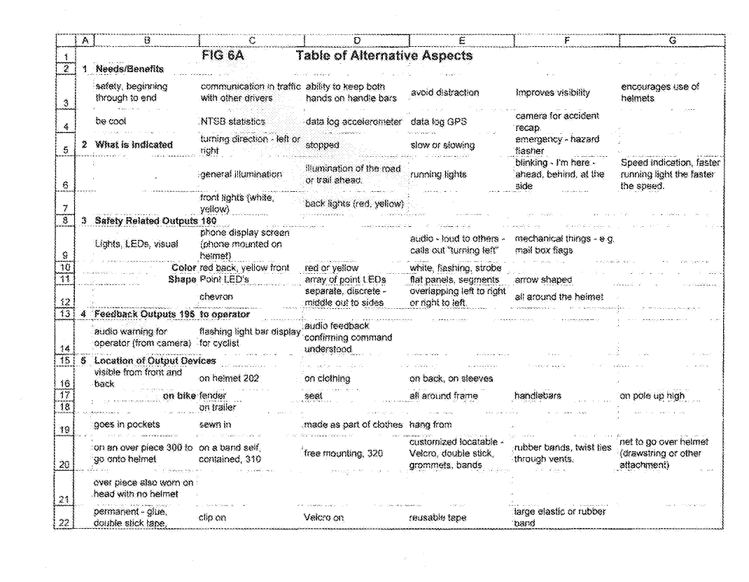

FIG. 5 illustrates an aspect of this invention in which the system 100 is an overpiece 300 comprising a free mounting frame 320 which can be placed over or onto a helmet, a head or another shape or structure. By virtue of one or more support members 322, the overpiece 300 will sit on the helmet and not fall off. An optional tightenable mechanism 312 may be used to reduce or eliminate the chance that the overpiece 300 will unintentionally come off the helmet. The at least one support member 322 may be of various materials and construction to meet the aesthetic and functional needs of the user. For example the at least one support member 322 may be a net or mesh. The optional tightenable mechanism 312 may be a drawstring. There may be one or more safety related outputs 180 and or feedback outputs 195 associated one or more of the support members 322.

As cameras and image processing and other forward looking sensors become more sophisticated, additional aspects of the safety related command inputs 112 may be performed by the camera and the system 100 without immediate need for cyclist action. For example, the system 100 may sound a horn if it senses another vehicle is cutting it off.

In addition to using a camera as a device to provide one or more command inputs 112, a camera can be a safety related output 180. For example it may be turned on at the command of the user to record a situation which they are encountering. As cameras and image processing become more sophisticated, additional aspects of the invention will become clearer.

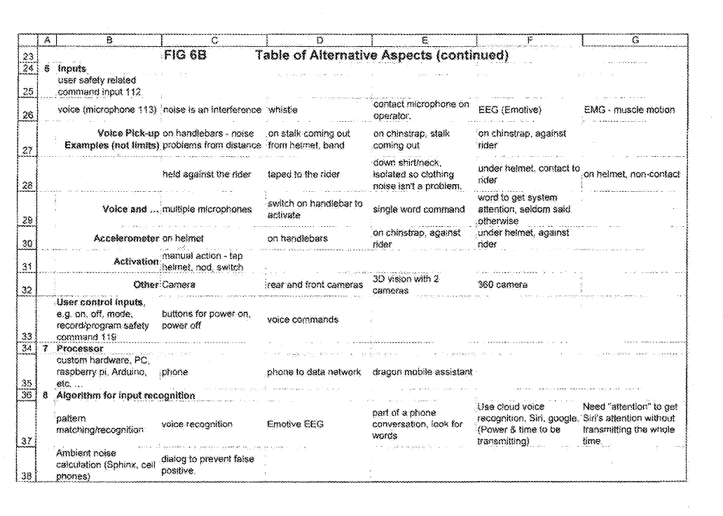

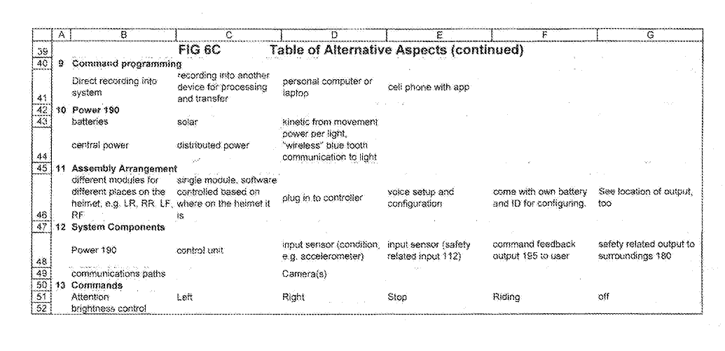

FIGS. 6A, 6B, and 6C are a table or chart of alternatives for various aspects of the system 100 of this invention. For example, rows 9 through 12 list example safety related outputs 180 which may be used, singly or in combination with other safety related outputs 180 which may be used in alternative aspects of this system. Similarly, rows 16 through 22 list one or more example locations where one or more where safety related outputs 180 may be positioned in alternative aspects of this system. Similarly, rows 25 through 32 list example inputs, which may be used singly or in combination with other inputs, by the operator to command or control the system 100 via a safety related command input 112 or a user control input 119. Alternative aspects or examples of the system 100 of this invention may be configured by those skilled in the art by combining one or more system components or aspects from one or more of the applicable groups in FIGS. 6A, 6B, and 6C, optionally with one or more of the aspects mentioned elsewhere herein.

As is recognized by one skilled in the art, the various functions of this system 100 may partitioned among various parts and components of the hardware. For example, the noise cancellation, voice recognition, and control module functions could be performed by a smart phone, either totally within itself or via communications to the external network, similar to the way in which Apple's Siri voice recognition works.

Although the disclosure has been described in detail for the purpose of illustration based on what is currently considered to be the most practical and preferred aspects, it is to be understood that such detail is solely for that purpose and that the disclosure is not limited to the disclosed aspects, but, on the contrary, is intended to cover modifications and equivalent arrangements. For example, it is to be understood that the present disclosure contemplates that, to the extent possible, one or more features of any aspect may be combined with one or more features of any other aspect.

What is claimed is:

1. A user activated signaling system mountable onto a helmet comprising:
at least one control unit which receives safety commands from the operator via one or more input devices, said control unit processing said safety commands and controllably activating one or more safety outputs based upon said safety commands; and
at least one power source to power at the at least one control unit and the one or more outputs.

2. The user activated signaling system of claim 1, wherein the system comprises a helmet mountable assembly.

3. The user activated signaling system of claim 2, wherein the helmet mountable assembly comprises a belt.

4. The user activated signaling system of claim 2, wherein the helmet mountable assembly comprises a net, a shell, or similarly stably mountable assembly.

5. The user activated signaling system of claim 1, wherein the at least one of the command inputs is at least one microphone.

6. The user activated signaling system of claim 1, wherein the at least one of the control unit, power source, inputs, and outputs are physically associable and dis-associable with a helmet.
